(19) United States
(12) Patent Application Publication
(10) Pub. No.: US 2018/0324801 A1
(43) Pub. Date: Nov. 8, 2018

(54) ACCESS POINT MANAGED CHANNEL CORRELATION FOR MU-MIMO

(71) Applicant: QUALCOMM Incorporated, San Diego, CA (US)

(72) Inventors: BadriSrinivasan Sampathkumar, Fremont, CA (US); Madhan Jaganathan, Cupertino, CA (US); Ahmed Ragab Elsherif, San Jose, CA (US)

(21) Appl. No.: 15/585,099

(22) Filed: May 2, 2017

(51) Int. Cl. H04W 72/04; H04B 7/0452; H04B 17/309; H04B 1/38

(52) U.S. Cl. CPC H04W 72/0453; H04B 7/0452; H04W 88/08; H04B 1/38; H04B 17/309

(57) ABSTRACT

Apparatuses and methods for reducing channel correlation between wireless nodes are disclosed. An apparatus may receive channel state information (CSI) from each of a plurality of wireless nodes and determine, for each of the plurality of wireless nodes, a level of channel correlation with other wireless nodes based, at least in part, on the received CSI. The apparatus may identify one or more of the plurality of wireless nodes for which the determined level of channel correlation is greater than or equal to a value, and then generate, for at least one of the identified wireless nodes, an instruction requesting at least one of the identified wireless nodes to adjust a parameter by an amount based on the determined level of channel correlation. The apparatus may provide the instruction for transmission to the at least one of the identified wireless nodes.

### TECHNICAL FIELD

The present disclosure relates generally to communication systems, and specifically to reducing channel correlation between wireless devices.

### BACKGROUND

A wireless local area network (WLAN) may be formed by one or more access points (APs) that provide a shared wireless communication medium for use by a number of client devices or stations (STAs). Each AP, which may correspond to a Basic Service Set (BSS), periodically broadcasts beacon frames to enable any STAs within wireless range of the AP to establish and/or maintain a communication link with the WLAN. An AP may concurrently transmit data as multiple spatial streams to a plurality of different STAs using multi-user multiple-input multiple-output (MU-MIMO) communications. For example, the AP may group a number of STAs together to form a MU-MIMO group, and then deliver queued downlink (DL) data to the group of STAs concurrently using MU-MIMO communications.

The wireless channels between the AP and each of the STAs may be physically correlated. The degree of channel correlation between a pair of STAs may be related to the angular positions of the pair of STAs relative to the AP. For example, a first pair of STAs having a relatively small difference in angular positions relative to the AP tend to have a higher degree of channel correlation than a second pair of STAs having a relatively large difference in angular positions relative to the AP. Because interference between wireless channels is related to channel correlation, a high degree of channel correlation between a group of STAs may degrade the ability of the AP to concurrently transmit data to the group of STAs using MU-MIMO communications. As a result, conventional APs may avoid grouping a number of STAs together for MU-MIMO communications if the channel correlation between the number of STAs exceeds a value for which channel interference may degrade the throughput and/or integrity of MU-MIMO data transmissions.

### SUMMARY

This Summary is provided to introduce in a simplified form a selection of concepts that are further described below in the Detailed Description. This summary is not intended to identify key features or essential features of the claimed subject matter, nor is it intended to limit the scope of the claimed subject matter.

Apparatuses and methods are disclosed for reducing channel correlation between wireless nodes or stations (STAs). In one aspect, an apparatus for wireless communication is disclosed. The apparatus may include an interface and a processing system. The interface may be configured to receive channel state information (CSI) from each of a plurality of wireless nodes. The processing system may be configured to determine, for each of the plurality of wireless nodes: a level of channel correlation with other wireless nodes based, at least in part, on the received CSI; identify one or more of the plurality of wireless nodes for which the determined level of channel correlation is greater than or equal to a value; and generate an instruction requesting at least one of the identified wireless nodes to adjust a parameter by an amount based on the determined level of channel correlation, wherein the interface is further configured to provide the instruction for transmission to the at least one of the identified wireless nodes.

In another aspect, a method for wireless communication is disclosed. The method may include receiving channel state information CSI from each of a plurality of wireless nodes; determining, for each of the plurality of wireless nodes, a level of channel correlation with other wireless nodes based, at least in part, on the received CSI; identifying one or more of the plurality of wireless nodes for which the determined level of channel correlation is greater than or equal to a value; generating an instruction requesting at least one of the identified wireless nodes to adjust a parameter by an amount based on the determined level of channel correlation; and providing the instruction for transmission to the at least one of the identified wireless nodes.

In another aspect, an apparatus for wireless communication is disclosed. The apparatus may include means for receiving CSI from each of a plurality of wireless nodes; means for determining, for each of the plurality of wireless nodes, a level of channel correlation with other wireless nodes based, at least in part, on the received CSI; means for identifying one or more of the plurality of wireless nodes for which the determined level of channel correlation is greater than or equal to a value; means for generating an instruction requesting at least one of the identified wireless nodes to adjust a parameter by an amount based on the determined level of channel correlation; and means for providing the instruction for transmission to the at least one of the identified wireless nodes.

In another aspect, a computer-readable medium is disclosed. The computer-readable medium may comprise instructions that, when executed by an apparatus, cause the apparatus to receive CSI from each of a plurality of wireless nodes; determine, for each of the plurality of wireless nodes, a level of channel correlation with other wireless nodes based, at least in part, on the received CSI; identify one or more of the plurality of wireless nodes for which the determined level of channel correlation is greater than or equal to a value; generate an instruction requesting at least one of the identified wireless nodes to adjust a parameter by an amount based on the determined level of channel correlation; and provide the instruction for transmission to the at least one of the identified wireless nodes.

In another aspect, a wireless node is disclosed. The wireless node may include an interface and a processing system. The interface may be configured to receive an instruction requesting the wireless node to adjust a parameter by an amount based on a level of channel correlation between the wireless node and a number of other wireless nodes. The processing system may be configured to adjust the parameter by the amount. In some aspects, the parameter comprises a cyclic shift diversity (CSD) value, and the processing system is further configured to adjust the CSD associated with one or more receive chains of the wireless node based on the CSD value. In other aspects, the parameter comprises an attenuation value, and the processing system is further configured to generate an attenuated signal by applying the attenuation value to a signal.

In another aspect, a wireless node is disclosed. The wireless node may include an interface and a processing system. The interface may be configured to receive CSI from each of a plurality of wireless devices. The processing system may be configured to: determine, for each of the plurality of wireless devices, a level of channel correlation with other wireless devices based, at least in part, on the received CSI; identify one or more of the plurality of wireless devices for which the determined level of channel correlation is greater than or equal to a value; and generate an instruction requesting at least one of the identified wireless devices to adjust a parameter by an amount based on the determined level of channel correlation, wherein the interface is further configured to provide the instruction for transmission to the at least one of the identified wireless devices.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a multiple-input multiple-output (MIMO) wireless system in accordance with various aspects of the present disclosure.

FIG. 2 shows a block diagram of an access point and a number of user terminals that may be implemented in a MIMO wireless system.

FIG. 3 shows a block diagram of an access point in accordance with various aspects of the present disclosure.

FIG. 4 shows a block diagram of a wireless device in accordance with various aspects of the present disclosure.

FIG. 5A shows a block diagram of a basic service set (BSS) shown to include an access point (AP) and a plurality of wireless devices in accordance with various aspects of the present disclosure.

FIG. 5B shows a block diagram depicting an example grouping of the wireless devices of the BSS of FIG. 5A in accordance with various aspects of the present disclosure.

FIG. 6 shows a timing diagram of an operation for reducing channel correlation between a number of wireless devices in accordance with various aspects of the present disclosure.

FIG. 7 shows an illustrative flow chart of an operation for reducing channel correlation between a number of wireless devices in accordance with various aspects of the present disclosure.

FIG. 8 shows an illustrative flow chart of an operation for grouping a number of wireless devices together for MU-MIMO communications in accordance with various aspects of the present disclosure.

FIG. 9 shows an illustrative flow chart of an operation for reducing channel correlation between a selected wireless device and a number of other wireless devices in accordance with various aspects of the present disclosure.

### DETAILED DESCRIPTION

Aspects of the present disclosure may assist in reducing channel correlation between a plurality of wireless devices associated with (or in wireless range of) an apparatus such as an access point (AP). The ability to reduce the degree of channel correlation between the plurality of wireless devices may allow the apparatus to group at least some of the plurality of wireless devices together for MU-MIMO communications. More specifically, reducing the degree of channel correlation between the plurality of wireless devices may reduce interference between wireless channels upon which the apparatus exchanges data with each of the plurality of wireless devices, which in turn may allow the apparatus to concurrently transmit different spatial streams to the plurality of wireless devices without transmission errors or data loss. In some implementations, the apparatus may determine, for each of the plurality of wireless devices, a level of channel correlation with other wireless devices, and then identify one or more of the wireless devices for which the determined level of channel correlation is greater than or equal to a value. In some aspects, the value may indicate a maximum level of channel correlation for which a number of corresponding wireless devices may be grouped together for MU-MIMO communications.

The apparatus may instruct one or more of the identified wireless devices to reduce corresponding levels of channel correlation with other wireless devices. For some implementations, the apparatus may generate an instruction requesting at least one of the identified wireless nodes to adjust a parameter by an amount based on the determined level of channel correlation, and may provide the instruction for transmission to the at least one of the identified wireless devices. A wireless device receiving the instruction may adjust its parameter by the indicated amount, for example, to reduce the level of channel correlation between itself and the other wireless devices. In addition, for some implementations, the apparatus may select one or more of the plurality of wireless devices to form a group based on at least one determined level of channel correlation, and may then provide multi-user multiple-input multiple-output (MU-MIMO) data for transmission to the group.

Aspects of the present disclosure may be described below in the context of wireless local area network (WLAN) systems for simplicity only. It is to be understood that aspects of the present disclosure are equally applicable to other wireless networks (e.g., cellular networks, pico networks, femto networks, satellite networks), as well as for systems using signals of one or more wired standards or protocols (e.g., Ethernet and/or HomePlug/PLC standards). As used herein, the terms “WLAN” and “Wi-Fi®” may include communications governed by the IEEE 802.11 family of standards, Bluetooth®, HiperLAN (a set of wireless standards, comparable to the IEEE 802.11 standards, used primarily in Europe), and other technologies having relatively short radio propagation range. Thus, the terms “WLAN” and “Wi-Fi®” may be used interchangeably herein.

In the following description, numerous specific details are set forth such as examples of specific components, circuits, and processes to provide a thorough understanding of the present disclosure. The term “coupled” as used herein means connected directly to or connected through one or more intervening components or circuits. The term “characteristics” as used herein may refer to one or more operating characteristics, parameters, or properties of a power amplifier including, for example, non-linear characteristics of the power amplifier. Also, in the following description and for purposes of explanation, specific nomenclature is set forth to provide a thorough understanding of the present disclosure. However, it will be apparent to one skilled in the art that these specific details may not be required to practice the example implementations. In other instances, well-known circuits and devices are shown in block diagram form to avoid obscuring the present disclosure. The present disclosure is not to be construed as limited to specific examples described herein but rather to include within their scopes all implementations defined by the appended claims.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims. Also, the example wireless communications devices may include components other than those shown.

### An Example Wireless Communication System

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, Radio Network Controller (“RNC”), evolved Node B (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

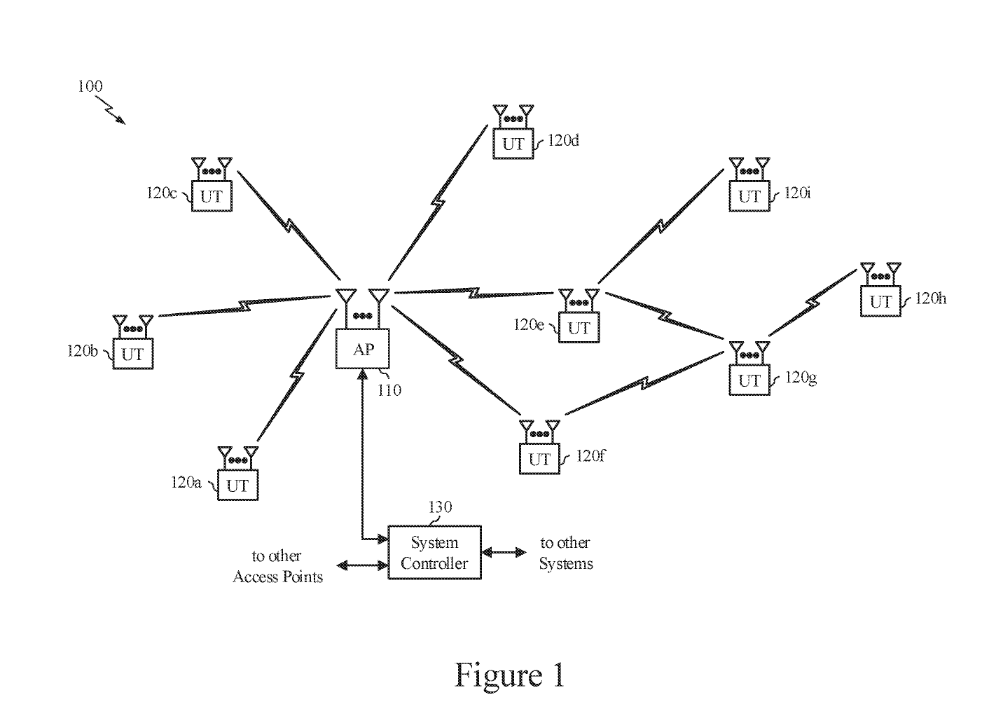

FIG. 1 shows an example wireless system 100 including an access point 110 and a number of user terminals 120a-120i. For simplicity, only one access point 110 is shown in FIG. 1. An access point, which is generally a fixed station that communicates with the user terminals 120a-120i, may also be referred to as a base station or a wireless device. A user terminal, which may be fixed or mobile, may also be referred to as a mobile station (STA) or a wireless device. The access point 110 may communicate with one or more of the user terminals 120a-120i via downlink channels and/or uplink channels. The downlink channel (e.g., forward link) represents the communication link from the access point 110 to the user terminals 120a-120i, and the uplink channel (e.g., reverse link) represents the communication link from the user terminals 120a-120i to the access point 110. The user terminals 120a-120i may also communicate with each other using peer-to-peer communication techniques. A system controller 130 may provide coordination and control for the access point 110 and/or for other access points within or otherwise associated with the wireless system 100 (other access points not shown for simplicity).

For implementations in which one or more of the user terminals 120a-120i may not support space-division multiple access (SDMA) signaling techniques, the access point 110 may be configured to communicate with the user terminals 120a-120i using both SDMA signaling techniques and non-SDMA signaling techniques. In this manner, the access point 110 may allow older versions of user terminals (e.g., “legacy” stations) that do not support SDMA signaling techniques to remain deployed in the wireless system 100 while allowing newer user terminals that support SDMA signaling techniques to be deployed within the wireless system 100.

The access point 110 may include a number (Nₐₚ) of antennas to facilitate multiple-input (MI) downlink transmissions and multiple-output (MO) uplink transmissions for the wireless system 100. A set (K) of selected ones of the user terminals 120a-120i may collectively provide multiple-output downlink transmissions and multiple-input uplink transmissions for the wireless system 100. For SDMA communications, the number of antennas on the access point 110 may be greater than or equal to the number of the selected ones of the user terminals 120a-120i (e.g., Nₐₚ≥K≥1) when the data streams for the selected ones of the user terminals 120a-120i are not multiplexed in code, frequency, or time. The number of the selected ones of the user terminals 120a-120i may be greater than the number of antennas on the access point 110 (e.g., K>Nₐₚ) when the data streams are multiplexed (e.g., using time-division multiple access (TDMA), code-division multiple access (CDMA), orthogonal frequency-division multiple access (OFDMA), and/or other suitable multiple-access signaling techniques). Each of the selected user terminals 120a-120i may transmit user-specific data to and/or receive user-specific data from the access point 110. In general, each of the selected user terminals 120a-120i may include a number (Nᵤₜ) of antennas. In some aspects, at least some of the selected user terminals 120a-120i may have different numbers of antennas.

The wireless system 100 may be a time division duplex (TDD) system or a frequency division duplex (FDD) system. For a TDD system, downlink and uplink communications may operate on the same frequency band. For an FDD system, downlink and uplink communications may operate on different frequency bands. In some aspects, the wireless system 100 may utilize a single carrier or multiple carriers for transmission. In other aspects, the wireless system 100 may implement TDMA signaling techniques.

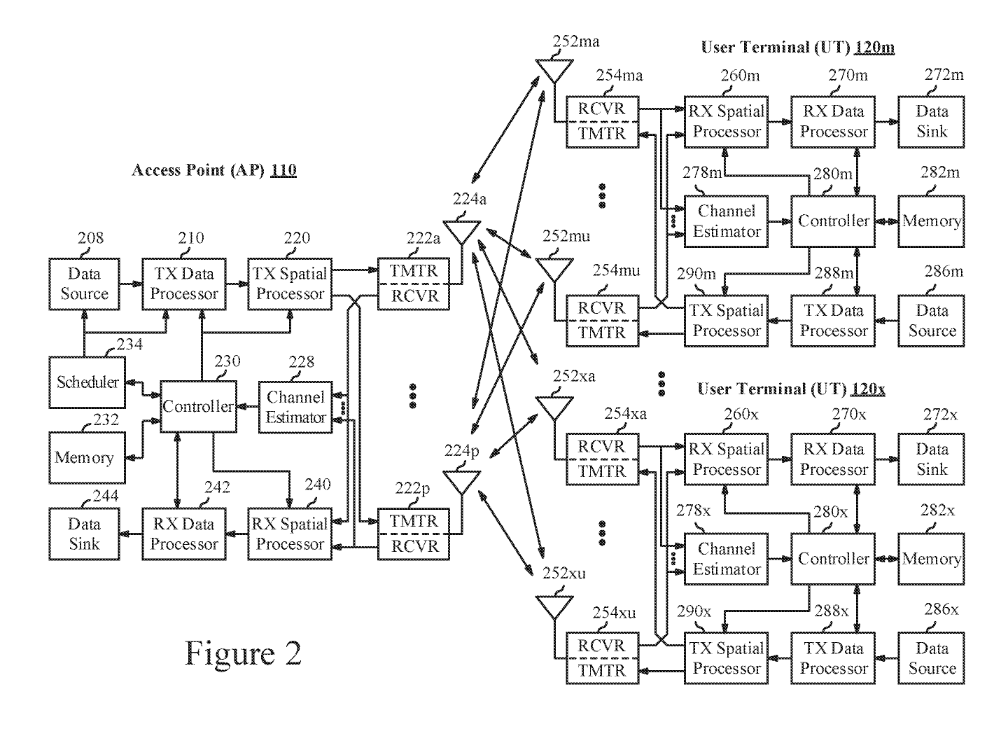

FIG. 2 shows the access point 110, a first user terminal 120m, and a second user terminal 120x of the wireless system 100 of FIG. 1. The access point 110 includes a number of antennas 224a-224p. The first user terminal 120m includes a number of antennas 252ma-252mu, and the second user terminal 120x includes a number of antennas 252xa-252xu. The access point 110 may be a transmitting entity for downlink communications, and may be a receiving entity for uplink communications. Referring also to FIG. 1, each of the user terminals 120a-120i may be a transmitting entity for uplink communications, and may be a receiving entity for downlink communications. As used herein, a “transmitting entity” may refer to an apparatus or device capable of transmitting data via a wireless channel, and a “receiving entity” may refer to an apparatus or device capable of receiving data via a wireless channel. In the following description, the subscript “dn” denotes the downlink channel, and the subscript “up” denotes the uplink channel. For example, a number (Nᵤₚ) of the user terminals 120a-120i may be selected for simultaneous transmission on the uplink channel, and a number (N_{dn}) of the user terminals 120a-120i may be selected for simultaneous transmission on the downlink channel. The number of the user terminals 120a-120i selected for uplink transmissions may or may not be equal to the number of the user terminals 120a-120i selected for downlink transmissions. In some aspects, the access point 110 and/or the user terminals 120a-120i may use beam-steering and/or other spatial processing techniques to communicate wireless signals with each other (and/or other wireless devices, not shown in FIGS. 1-2 for simplicity).

As shown in FIG. 2, the first user terminal 120m includes a TX data processor 288m that receives traffic data from a data source 286m and receives control data from a controller 280m, and the second user terminal 120x includes a TX data processor 288x that receives traffic data from a data source 286x and receives control data from a controller 280x. For example, in the first user terminal 120m, the TX data processor 288m processes (e.g., encodes, interleaves, and modulates) traffic data based on a selected coding and modulation scheme, and generates a stream of data symbols. A TX spatial processor 290m performs spatial processing to convert the data symbol stream to a number of transmit symbol streams to be transmitted via the antennas 252ma-252mu. Similarly, in the second user terminal 120x, the TX data processor 288x processes (e.g., encodes, interleaves, and modulates) traffic data based on a selected coding and modulation scheme, and generates a stream of data symbols. A TX spatial processor 290x performs spatial processing to convert the data symbol stream to a number of transmit symbol streams to be transmitted via the antennas 252xa-252xu.

The first user terminal 120m includes a number of transceiver units 254ma-254mu, each of which includes a transmitter portion “TMTR” and a receiver portion “RCVR.” Each of the transceiver units 254ma-254mu receives and processes (e.g., converts to analog, amplifies, filters, and frequency up-converts) a respective transmit symbol stream to generate an uplink signal, which in turn may be output for transmission via the antennas 252ma-252mu of the first user terminal 120m. Similarly, the second user terminal 120x includes a number of transceiver units 254xa-254xu, each of which includes a transmitter portion “TMTR” and a receiver portion “RCVR.” Each of the transceiver units 254xa-254xu receives and processes (e.g., converts to analog, amplifies, filters, and frequency up-converts) a respective transmit symbol stream to generate an uplink signal, which in turn may be output for transmission via the antennas 252xa-252xu of the second user terminal 120x.

At the access point 110, antennas 224a-224p may receive uplink signals from the first user terminal 120m and/or from the second user terminal 120x. Each of the antennas 224a-224p provides a received signal to a respective one of a number of transceiver units 222a-222p. Each of the transceiver units 222a-222p includes a transmitter portion “TMTR” and a receiver portion “RCVR,” and performs processing complementary to that performed by transmitter portions of the transceiver units 254ma-254mu of the first user terminal 120m and/or performs processing complementary to that performed by transmitter portions of the transceiver units 254xa-254xu of the second user terminal 120x. An RX spatial processor 240 performs receiver spatial processing on the received symbol streams from the receiver portions of transceiver units 222a-222p to generate uplink data symbol streams. The receiver spatial processing may be performed in accordance with a channel correlation matrix inversion (CCMI), a minimum mean square error (MMSE), a soft interference cancellation (SIC), or other suitable technique. Each recovered uplink data symbol stream may be an estimate of a data symbol stream transmitted by a respective one of user terminals 120. An RX data processor 242 processes (e.g., demodulates, de-interleaves, and decodes) each recovered uplink data symbol stream based on the modulation and coding scheme used for that stream to obtain decoded data. The decoded data for each of the user terminals 120 may be provided to a data sink 244 for storage and/or a controller 230 for further processing.

The access point 110 also includes a TX data processor 210 to receive data from a data source 208, to receive control data from a controller 230, and/or to receive additional data from a scheduler 234. The various types of data may be sent on different transport channels. TX data processor 210 processes (e.g., encodes, interleaves, and modulates) the data for each of the user terminals 120 based on the modulation and coding scheme selected for that user terminal 120. The TX data processor 210 may provide a respective downlink data symbol stream for the first user terminal 120m and the second user terminal 120x. A TX spatial processor 220 performs spatial processing (such as a precoding or beamforming) to convert the downlink data symbol streams to a number (N_{dn}) of transmit symbol streams to be transmitted via the antennas 224a-224p of the access point 110. The transmitter portion of each of the transceiver units 222a-222p receives and processes a respective transmit symbol stream to generate a downlink signal. The transceiver units 222a-222p may provide the downlink signals for transmission via the antennas 224a-224p.

Antennas 252ma-252mu of the first user terminal 120m may receive downlink signals from the access point 110, and antennas 252xa-252xu of the second user terminal 120x may receive downlink signals from the access point 110. Each of the transceiver units 254ma-254mu in the first user terminal 120m processes a received signal from an associated one of antennas 252ma-252mu to recover a received symbol stream, and each of the transceiver units 254xa-254xu in the second user terminal 120x processes a received signal from an associated one of antennas 252xa-252xu to recover a received symbol stream. An RX spatial processor 260m within the first user terminal 120m performs receiver spatial processing on the received symbol streams to generate a downlink data symbol stream, and an RX spatial processor 260x within the second user terminal 120x performs receiver spatial processing on the received symbol streams to generate a downlink data symbol stream. The receiver spatial processing may be performed in accordance with the CCMI, MMSE, or other suitable technique. An RX data processor 270m within the first user terminal 120m processes (e.g., demodulates, de-interleaves and decodes) the recovered downlink data symbol stream to obtain decoded data, and an RX data processor 270x within the second user terminal 120x processes (e.g., demodulates, de-interleaves and decodes) the recovered downlink data symbol stream to obtain decoded data.

A channel estimator 278m within the first user terminal 120m may estimate the downlink channel response, and may provide downlink channel estimates (e.g., which may include channel gain estimates, SNR estimates, noise variance, and so on), and a channel estimator 278x within the second user terminal 120x may estimate the downlink channel response, and may provide downlink channel estimates (e.g., which may include channel gain estimates, SNR estimates, noise variance, and so on). Similarly, a channel estimator 228 within the access point 110 may estimate the uplink channel response, and may provide uplink channel estimates. A controller 280m within the first user terminal 120m may derive the spatial filter matrix for the first user terminal 120m based on the downlink channel response matrix H_{dn,m}, and a controller 280x within the second user terminal 120x may derive the spatial filter matrix for the second user terminal 120x based on the downlink channel response matrix H_{dn,x}. The controller 280m and the controller 280x may send feedback information (e.g., the downlink and/or uplink eigenvectors, eigenvalues, SNR estimates, and so on) to the access point 110.

A controller 230 may derive the spatial filter matrix for the access point 110 based on the effective uplink channel response matrix H_{up,eff}. In addition, the operation of various processing units within the access point 110 may be controlled and/or coordinated by controller 230, the operation of various processing units within the first user terminal 120m may be controlled and/or coordinated by controller 280m, and the operation of various processing units within the second user terminal 120x may be controlled and/or coordinated by controller 280x.

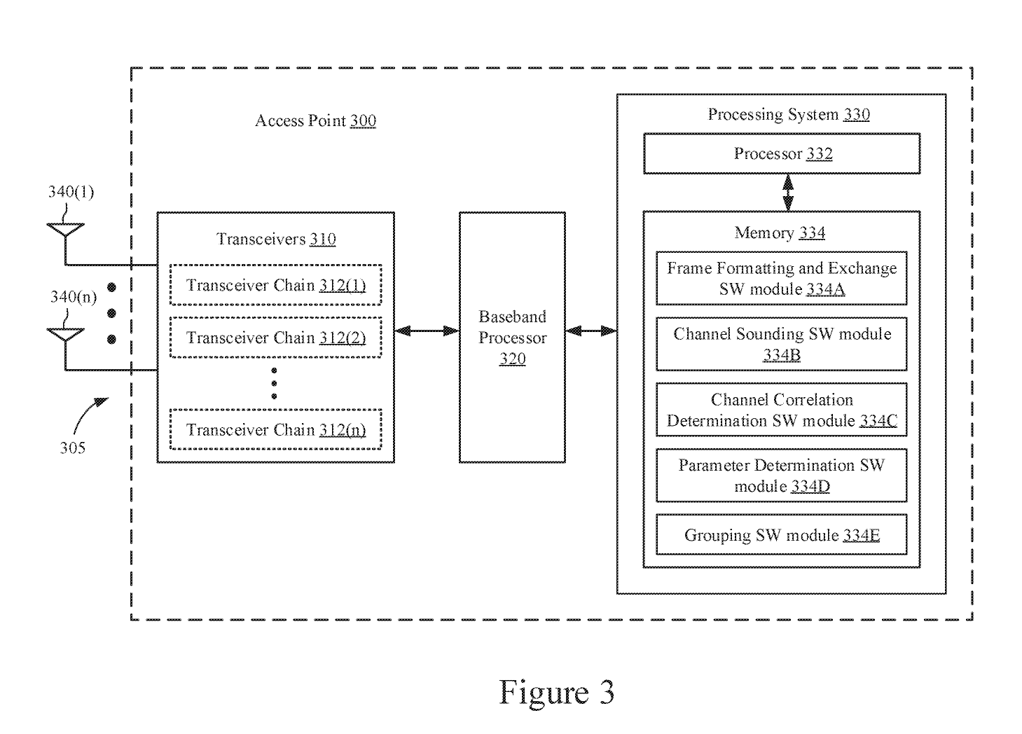

FIG. 3 shows a block diagram of an access point 300 in accordance with various aspects of the present disclosure. The access point 300 may be one implementation of the access point 110 of FIGS. 1-2. The access point 300 may include at least a number of transceivers 310, a baseband processor 320, a processing system 330, and a number of antennas 340(1)-340(n). Other well-known components of access point 300 are not shown in FIG. 3 for simplicity.

The transceivers 310 may be used to transmit signals to and receive signals from other wireless devices such as wireless stations and user terminals (e.g., user terminals 120 of FIGS. 1-2). More specifically, the transceivers 310 may include a plurality of transceiver chains 312(1)-312(n), each containing a transmit chain and a receive chain (not individually shown for simplicity). For example, the transceiver chain 312(1) may include a first transmit chain to process (e.g., up-convert, filter, and amplify) wireless signals for transmission by one or more of antennas 340(1)-340(n) to a number of other wireless devices, and may include a first receive chain to process (e.g., amplify, filter, and down-convert) wireless signals received from a number of other wireless devices via one or more of antennas 340(1)-340(n). Further, although not shown in FIG. 3 for simplicity, each of the transceiver chains 312(1)-312(n) may include a number of well-known components for transmitting and receiving wireless signals via antennas 340(1)-340(n). These well-known components may include, for example, power amplifiers, low noise amplifiers, attenuators, filters, mixers, impedance matching circuitry, and the like. In some aspects, the transceivers 310 may be configured to receive channel state information (CSI) from each of a plurality of wireless devices.

The transceivers 310 may be coupled to antennas 340(1)-340(n) either directly or through an antenna selection circuit (not shown for simplicity). For some implementations, the antennas 340(1)-340(n) and transceivers 310 may form or be part of an interface 305. The interface 305 may be configured to receive or obtain wireless signals transmitted from one or more other wireless devices, and may be configured to transmit wireless signals to one or more other wireless devices. For implementations in which the access point 300 may operate in a wireless network that supports MU-MIMO communications, the interface 305 may be configured to receive or obtain a plurality of spatial streams containing data from multiple users, and may be configured to transmit a plurality of spatial streams containing data intended for multiple users.

The transceivers 310 may be coupled to the baseband processor 320 via any suitable connection, interface, or bus system. The baseband processor 320 may be used to process signals received from processing system 330 and to forward the processed signals to transceivers 310 for transmission via one or more of antennas 340(1)-340(n), and may be used to process signals received from one or more of antennas 340(1)-340(n) via transceivers 310 and to forward the processed signals to processing system 330. The baseband processor 320 is well known in the art and is therefore not described in detail herein. For example, the baseband processor 320 may include a variety of known elements such as (but not limited to) coders, data modems, and digital data switching and storage components. Although the baseband processor 320 is depicted in FIG. 3 as being coupled between the transceivers 310 and the processing system 330, for other implementations, the transceivers 310, the baseband processor 320, and/or the processing system 330 may be connected together using one or more buses (not shown for simplicity).

The processing system 330 may include a processor 332 and a memory 334. The processor 332 may be coupled to memory 334 and to baseband processor 320 via any suitable connection, interface, or bus system. The processor 332, which may also be referred to as a central processing unit (CPU), may perform logical and arithmetic operations based on program instructions stored within the memory 334. More specifically, the processor 332 may be one or more suitable processors capable of executing scripts or instructions of one or more software programs stored within memory 334.

The memory 334, which may be any suitable type of memory or storage device, may store data to be transmitted from access point 300, may store data received from other devices, and may store other suitable information for facilitating the operation of access point 300. In some aspects, the memory 334 may include a non-transitory computer-readable medium (e.g., one or more nonvolatile memory elements, such as EPROM, EEPROM, Flash memory, a hard drive, and so on) that may store one or more programs or software modules comprising instructions for execution by the processor 332. For example, in some implementations, the memory 334 may store at least the following software (SW) modules:

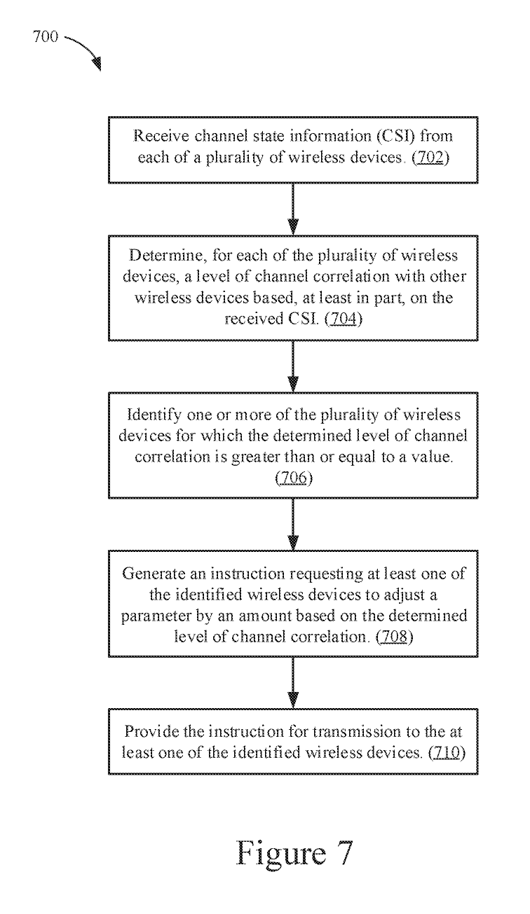

a frame formatting and exchange software module 334A to facilitate the creation and exchange of any suitable frames (e.g., data frames, control frames, and management frames) used in communications between access point 300 and other wireless devices (e.g., as described below for one or more operations of FIGS. 7-9);

a channel sounding software module 334B to perform channel sounding operations with other wireless devices and to receive channel state information (CSI) from one or more of the other wireless devices (e.g., as described below for one or more operations of FIGS. 7-9);

a channel correlation determination software module 334C to determine levels of channel correlation between each of a plurality of other wireless devices and to identify wireless devices for which the determined levels of channel correlation is greater than or equal to a value (e.g., as described below for one or more operations of FIGS. 7-9);

a parameter determination software module 334D to determine an amount by which a parameter of one of more of the identified wireless devices is to be adjusted (e.g., as described below for one or more operations of FIGS. 7-9); and

a grouping software module 334E to select a number of wireless devices to form a MU-MIMO group based on at least one determined level of channel correlation and/or to remove one or more wireless devices from the MU-MIMO group based on the at least one determined level of channel correlation (e.g., as described below for one or more operations of FIGS. 7-9).

Each software module includes instructions that, when executed by the processor 332, cause the access point 300 to perform the corresponding functions. The computer-readable medium of memory 334 thus includes instructions for performing all or a portion of the operations described below with respect to FIGS. 7-9. For example, the processor 332 may execute the frame formatting and exchange software module 334A to facilitate the creation and exchange of any suitable frames (e.g., data frames, control frames, and management frames) used in communications between access point 300 and other wireless devices. In some aspects, the processor 332 may execute the frame formatting and exchange software module 334A to generate an action frame containing instructions that requests at least one of the identified wireless devices to adjust its parameter by the amount determined by the parameter determination software module 334D.

The processor 332 may execute the channel sounding software module 334B to perform channel sounding operations with other wireless devices and to receive channel state information (CSI) from one or more of the other wireless devices. For some implementations, the processor 332 may execute the channel sounding software module 334B to create a null data packet announcement (NDPA) for transmission to a number of wireless devices. In some aspects, the NDPA may signal that a channel sounding operation has been initiated, and may indicate which of the wireless devices are to participate in the channel sounding operation. Execution of the channel sounding software module 334B may also be used to create a null data packet (NDP) for transmission to the wireless devices. The NDP may contain a number of sounding sequences from which the wireless devices indicated in the NPDA can estimate channel conditions and generate channel state information (CSI). The access point 300 may receive CSI from the indicated wireless devices in a number of feedback frames such as, for example, compressed beamforming (CBF) frames.

For some implementations, the processor 332 may execute the channel sounding software module 334B to periodically perform sounding operations with the indicated wireless devices (e.g., at suitable intervals or after suitable time periods) to receive updated CSI from the indicated wireless devices. The updated CSI may be used by the access point 300 to periodically monitor levels of channel correlation between the wireless devices, for example, to determine whether additional adjustments to the wireless devices' parameters may be desired.

The processor 332 may execute the channel correlation determination software module 334C to determine levels of channel correlation between each of a plurality of other wireless devices and to identify wireless devices for which the determined levels of channel correlation is greater than or equal to the value. For some implementations, execution of the channel correlation determination software module 334C may cause the access point 300 to determine, for a respective wireless device, the level of channel correlation with other wireless devices based, at least in part, on CSI received from the wireless devices. The access point 300 may then identify one or more of the wireless devices for which the determined level of channel correlation is greater than or equal to the value. In some aspects, the value may correspond to a level of channel correlation for which inter-channel interference is sufficient to degrade MU-MIMO data transmissions from the access point 300 to the wireless devices. In other aspects, the value may indicate a maximum level of channel correlation for which a number of corresponding wireless devices may be grouped together for MU-MIMO communications with the access point 300.

The processor 332 may execute the parameter determination software module 334D to determine an amount by which a parameter of one of more of the identified wireless devices is to be adjusted. In some aspects, the parameter may be a baseband parameter, for example, that can affect one or more operating characteristics of a baseband processor. The amount by which the parameter is to be adjusted may be based on determined levels of channel correlation, and may be selected to reduce the level of channel correlation to an amount that is less than the value. The access point 300 may generate an instruction requesting at least one of the identified wireless devices to adjust the parameter by the determined amount (which may also be referred to herein as the “determined adjustment amount”). In some aspects, the parameter may be a cyclic shift diversity (CSD), and the determined adjustment amount may be a CSD value (such as to be applied to a signal received by the identified wireless device). In other aspects, the parameter may be a set of attenuation (α) and time delay (n₀) parameters, and the determined adjustment amount may be attenuation and time delay values (such as to be applied to a signal received by the identified wireless device). For example, the identified wireless device may apply the attenuation and delay values to a signal to generate an attenuated signal, and then generate an artificial multipath signal (Y′[n]) by summing the signal and the attenuated signal. The artificial multipath signal may be introduced into the receive path or chain of the identified wireless device, which in turn may change the channel conditions as seen by the AP (e.g., in a manner that reduces the level of channel correlation between the identified wireless device and other nearby wireless devices).

For some implementations, the access point 300 may determine whether a respective one of the identified wireless devices is to apply a CSD value to received signals or to introduce an artificial multipath signal into its receive path based, at least in part, on the capabilities of the respective wireless device. For example, introducing the artificial multipath signal into the receive path of the respective wireless device may allow the access point 300 to control levels of channel correlation between different wireless devices using two parameters (e.g., the attenuation value and the time delay value), while altering the CSD applied to received signals of the respective wireless device may allow the access point 300 to control levels of channel correlation between different wireless devices using only one parameter (e.g., the CSD adjustment value). More specifically, while introducing an artificial multipath signal into the receive path of the respective wireless device may reduce levels of channel correlation across various frequencies (e.g., on different subcarriers), adjusting the CSD applied to the receive path of the respective wireless device appears as a linear phase shift across all subcarriers. Accordingly, it may be desirable for the access point 300 to instruct the respective wireless device to introduce an artificial multipath signal into its receive path unless the respective wireless device lacks the capability or would be too complicated; otherwise, the access point 300 may instruct the respective wireless device to adjust the CSD applied to its receive path.

The access point 300 may provide the instructions for transmission to the at least one of the identified wireless devices. For some implementations, the processor 332 may execute the frame formatting and exchange software module 334A to provide the instructions in frames or packets for transmission to the identified wireless devices via baseband processor 320, the transceivers 310, and one or more of the antennas 340(1)-340(n). In some aspects, the processor 332 may execute the frame formatting and exchange software module 334A to generate action frames (or any other suitable frames or packets), and the instructions may be provided within an information element (IE) or a vendor-specific information element (VSIE) of action frames. In other aspects, the instructions may be contained within any suitable portion (or appended to) of action frames (or any other suitable frames or packets).

The processor 332 may execute the grouping software module 334E to select a number of wireless devices to form a group for MU-MIMO communications and/or to remove one or more wireless devices from the MU-MIMO group based on their determined levels of channel correlation. The wireless devices may be selected for inclusion in the MU-MIMO group based on a number of factors including, for example, corresponding levels of channel correlation, per-peer queue depth, and medium access control (MAC) efficiency. For some implementations, the processor 332 may execute the grouping software module 334E in conjunction with the channel correlation determination software module 334C to determine whether each of the wireless devices included within an existing MU-MIMO group should remain within or be removed from the existing MU-MIMO group and/or whether one or more other wireless devices should be admitted to the existing MU-MIMO group. For example, if execution of the channel correlation determination software module 334C determines that the channel correlation between a particular wireless device and other wireless devices within the existing MU-MIMO group is greater than or equal to the value, then the grouping software module 334E may be executed to remove the particular wireless device from the existing MU-MIMO group.

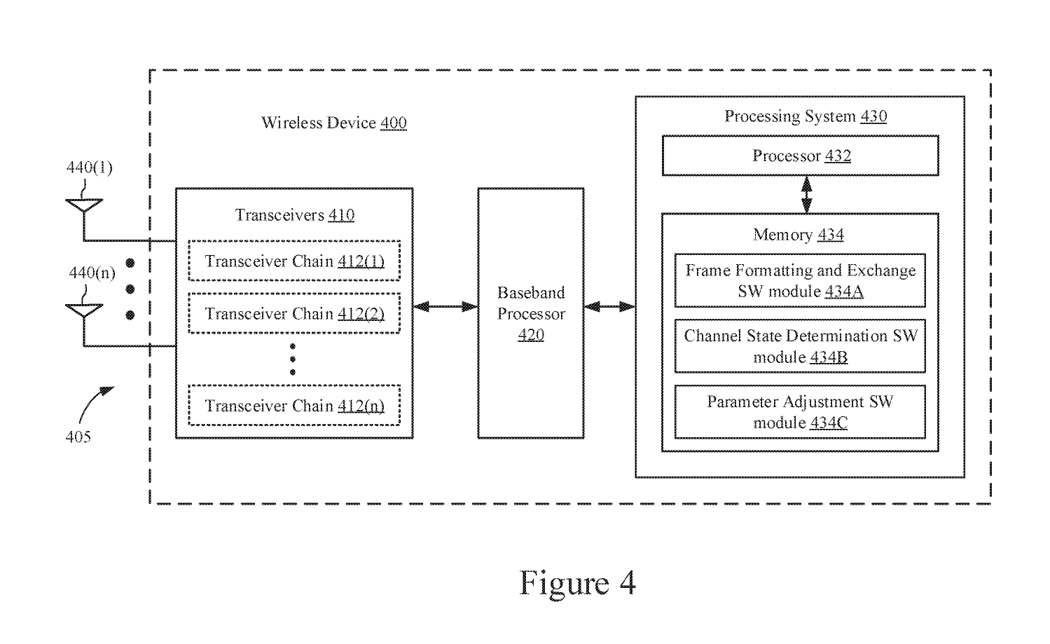

FIG. 4 shows a block diagram of a wireless device 400 in accordance with various aspects of the present disclosure. The wireless device 400 may be one implementation of the user terminals 120 of FIGS. 1-2 or one implementation of a wireless station (STA). The wireless device 400 may include at least a number of transceivers 410, a baseband processor 420, a processing system 430, and a number of antennas 440(1)-440(n). Other well-known components of wireless device 400 are not shown in FIG. 4 for simplicity.

The transceivers 410 may be used to transmit signals to and receive signals from other wireless devices such as access points (e.g., access point 110 of FIGS. 1-2 or the access point 300 of FIG. 3), wireless stations, and user terminals (e.g., user terminals 120 of FIGS. 1-2), and may be used to scan the surrounding environment to detect and identify nearby access points and/or other wireless devices (e.g., within wireless range of wireless device 400). More specifically, the transceivers 410 may include a plurality of transceiver chains 412(1)-412(n), each containing a transmit chain and a receive chain (not individually shown for simplicity). For example, the transceiver chain 412(1) may include a first transmit chain to process (e.g., up-convert, filter, and amplify) wireless signals for transmission by one or more of antennas 440(1)-440(n) to a number of other wireless devices, and may include a first receive chain to process (e.g., amplify, filter, and down-convert) wireless signals received from a number of other wireless devices via one or more of antennas 440(1)-440(n). Further, although not shown in FIG. 4 for simplicity, each of the transceiver chains 412(1)-412(n) may include a number of well-known components for transmitting and receiving wireless signals via antennas 440(1)-440(n). These well-known components may include, for example, power amplifiers, low noise amplifiers, attenuators, filters, mixers, impedance matching circuitry, and the like.

The transceivers 410 may be coupled to antennas 440(1)-440(n) either directly or through an antenna selection circuit (not shown for simplicity). For some implementations, the antennas 440(1)-440(n) and transceivers 410 may form or be part of an interface 405. The interface 405 may be configured to receive or obtain wireless signals transmitted from one or more other wireless devices, and may be configured to transmit wireless signals to one or more other wireless devices. For implementations in which the wireless device 400 may operate in a wireless network that supports MU-MIMO communications, the interface 405 may be configured to receive or obtain a plurality of spatial streams corresponding to MU-MIMO communications, and may be configured to transmit a plurality of spatial streams corresponding to MU-MIMO communications.

The transceivers 410 may be coupled to the baseband processor 420 via any suitable connection, interface, or bus system. The baseband processor 420 may be used to process signals received from processing system 430 and to forward the processed signals to transceivers 410 for transmission via one or more of antennas 440(1)-440(n), and may be used to process signals received from one or more of antennas 440(1)-440(n) via transceivers 410 and to forward the processed signals to processing system 430. The baseband processor 420 is well known in the art and is therefore not described in detail herein. For example, the baseband processor 420 may include a variety of known elements such as (but not limited to) coders, data modems, and digital data switching and storage components. Although the baseband processor 420 is depicted in FIG. 4 as being coupled between the transceivers 410 and the processing system 430, for other implementations, the transceivers 410, the baseband processor 420, and/or the processing system 430 may be connected together using one or more buses (not shown for simplicity).

The processing system 430 may include a processor 432 and a memory 434. The processor 432 may be coupled to memory 434 and to baseband processor 420 via any suitable connection, interface, or bus system. The processor 432, which may also be referred to as a CPU, may perform logical and arithmetic operations based on program instructions stored within the memory 434. More specifically, the processor 432 may be one or more suitable processors capable of executing scripts or instructions of one or more software programs stored within memory 434.

The memory 434, which may be any suitable type of memory or storage device, may store data to be transmitted from wireless device 400, may store data received from other devices, and may store other suitable information for facilitating the operation of wireless device 400. In some aspects, the memory 434 may include a non-transitory computer-readable medium (e.g., one or more nonvolatile memory elements, such as EPROM, EEPROM, Flash memory, a hard drive, and so on) that may store one or more programs or software (SW) modules comprising instructions for execution by the processor 432. For example, in some implementations, the memory 434 may store at least the following software (SW) modules:

a frame formatting and exchange software module 434A to facilitate the creation and exchange of any suitable frames (e.g., data frames, control frames, and management frames) used in communications between wireless device 400 and other wireless devices (e.g., as described below for one or more operations of FIGS. 7-9);

a channel state determination software module 434B to estimate channel conditions and generate channel state information (CSI) based on sounding sequences transmitted from other wireless devices (e.g., as described below for one or more operations of FIGS. 7-9); and

a parameter adjustment software module 434C to adjust a parameter by an amount indicated in one or more instructions received from another wireless device (e.g., as described below for one or more operations of FIGS. 7-9).

Each software module includes instructions that, when executed by the processor 432, cause the wireless device 400 to perform the corresponding functions. The computer-readable medium of memory 434 thus includes instructions for performing all or a portion of the operations described below with respect to FIGS. 7-9. For example, the processor 432 may execute the frame formatting and exchange software module 434A to facilitate the creation and exchange of any suitable frames (e.g., data frames, control frames, and management frames) used in communications between wireless device 400 and other wireless devices.

The processor 432 may execute the channel state determination software module 434B to estimate channel conditions and generate channel state information (CSI) based on sounding sequences transmitted from other wireless devices. For some implementations, the processor 432 may execute the channel state determination software module 434B to receive sounding sequences contained in NDPs transmitted from an access point (e.g., access point 110 of FIGS. 1-2 or access point 300 of FIG. 3), and to generate CSI based on the received sounding sequences. The CSI may be provided to the access point in a feedback frame such as, for example, a compressed beamforming (CBF) frame. In some aspects, the feedback frame may include a compressed beamforming matrix and a beamforming report.

The processor 432 may execute the parameter adjustment software module 434C to adjust a parameter by an amount indicated in one or more instructions received from another wireless device (e.g., by the determined adjustment amount). As discussed above, the amount by which the parameter is to be adjusted may be based on the level of channel correlation determined by the access point, and may be selected to reduce the level of channel correlation to an amount that is less than the value. The parameter may be a baseband parameter, for example, that can affect one or more operating characteristics of the baseband processor 420. For some implementations, execution of the parameter adjustment software module 434C may cause the baseband processor 420 to adjust the CSD associated with one or more receive chains of the transceivers 410. More specifically, the baseband processor 420 may apply a CSD value to signals received by the wireless device 400, for example, to reduce the level of channel correlation between wireless device 400 and other wireless devices. In some aspects, the CSD value determined by the AP may be a static value. In other aspects, the CSD value determined by the AP may be dynamically adjusted based on, for example, channel conditions, noise levels, multi-path effects, and the like.

For other implementations, execution of the parameter adjustment software module 434C may cause the baseband processor 420 to adjust received signals in the frequency domain or the time domain. More specifically, the baseband processor 420 may apply a set of attenuation (α) and time delay (n₀) values to a received signal to generate an attenuated signal, and may generate an artificial multipath signal (Y′[n]) by summing the received signal and the attenuated signal, and then introduce the artificial multipath signal into one or more of the receive paths of the wireless device 400. Introduction of the artificial multipath signal into one or more of the receive paths of the wireless device 400 may change the channel conditions as seen by the AP, for example, in a manner that reduces the level of channel correlation between the identified wireless device and other nearby wireless devices.

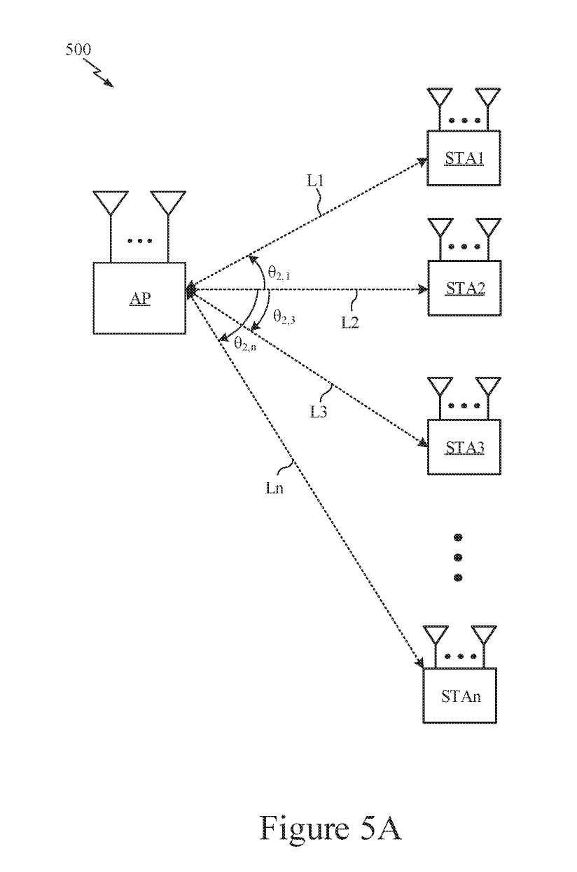

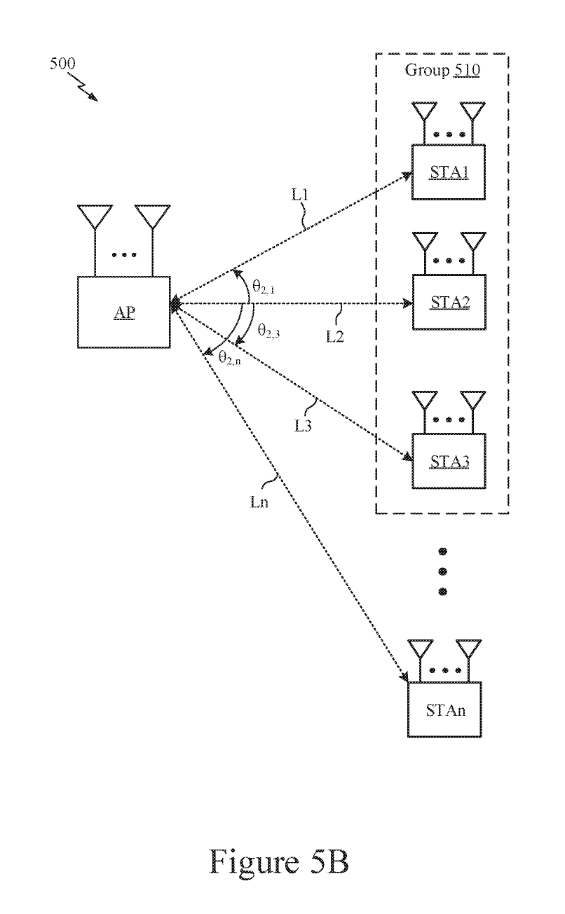

FIG. 5A shows a block diagram of a basic service set (BSS) 500 shown to include an access point (AP) and a plurality of wireless devices (STA1-STAn) in accordance with various aspects of the present disclosure. The AP may be one implementation of the access point 110 of FIGS. 1-2 or the access point 300 of FIG. 3. Each of the wireless devices STA1-STAn may be one implementation of the user terminals 120 of FIGS. 1-2 or the wireless device 400 of FIG. 4. As depicted in FIG. 5A, the AP and STA1 may exchange data via a first wireless channel or link L1, the AP and STA2 may exchange data via a second wireless channel or link L2, the AP and STA3 may exchange data via a third wireless channel or link L3, and the AP and STAn may exchange data via n^{th} wireless channel or link Ln. Further, for purposes of discussion herein, the angular position of STA2 relative to the AP differs by an angle θ_{2,1} with respect to the angular position of STA1 relative to the AP, the angular position of STA2 relative to the AP differs by an angle θ_{2,3} with respect to the angular position of STA3 relative to the AP, and the angular position of STA2 relative to the AP differs by an angle θ_{2,n} with respect to the angular position of STAn relative to the AP.

As mentioned above, the level of channel correlation between the STAs in a group may be related to the angular positions of the STAs relative to the AP. More specifically, as the difference in angular positions of a pair of STAs relative to the AP becomes smaller, the level of channel correlation between the pair of STAs typically increases; conversely, as the difference in angular positions of the pair of STAs relative to the AP becomes greater, the level of channel correlation between the pair of STAs typically decreases. For example, because the difference in angular positions of STA1 and STA2 (e.g., as indicated by the angle θ_{2,1}) is smaller than the difference in angular positions of STA2 and STAn (e.g., as indicated by the angle θ_{2,n}), the level of channel correlation between STA1 and STA2 is typically less than the level of channel correlation between STA2 and STAn. Thus, for at least some embodiments, the determined amount by which a given STA is instructed to adjust its parameter value may be based, at least in part, on the angles between the given STA and each of a number of other STAs relative to the AP.

For some implementations, the AP may use angle information of signals received from each of the wireless devices STA1-STAn as indicators of levels of channel correlation between wireless devices STA1-STAn. In some aspects, the AP may derive angle information of signals received from the wireless devices STA1-STAn based on estimated channel conditions of the links L1-Ln between the AP and each of the wireless devices STA1-STAn. For one example, if the AP determines that the value of the angle θ_{2,1} between STA1 and STA2 is less than a value, then the AP may identify one or both of STA1 and STA2 as candidates for parameter adjustments. Conversely, if the AP determines that the value of the angle θ_{2,n} between STA1 and STAn is not less than the value, then the AP may not identify either STA2 or STAn as candidates for parameter adjustments.

The ability of an AP (e.g., access point 300) to concurrently transmit DL MU-MIMO data to a plurality of wireless devices (e.g., user terminals 120, wireless devices 400, or STA1-STAn) may be improved by reducing levels of channel correlation between the plurality of wireless devices, for example, by reducing the inter-channel interference between spatial streams transmitted from the AP to multiple wireless devices. Reducing the interference between spatial streams transmitted to different users or STAs may reduce packet error rates and data loss, and may allow greater numbers of users or STAs to be grouped together for DL MU-MIMO communications, thereby increasing medium utilization and data throughput.

More specifically, the levels of channel correlation between the wireless devices STA1-STAn may be determined by analyzing estimated channel conditions of the wireless links L1-Ln between the AP and the wireless devices STA1-STAn, respectively. Although each of wireless devices STA1-STAn can estimate channel conditions of its associated link with the AP, each of wireless devices STA1-STAn is typically unaware of the channel conditions of links between the AP and other ones of STA1-STAn. Thus, in accordance with various aspects of the present disclosure, the AP may receive CSI from each of wireless devices STA1-STAn, and then determine, for each of wireless devices STA1-STAn, a level of channel correlation between the other wireless devices STA1-STAn.

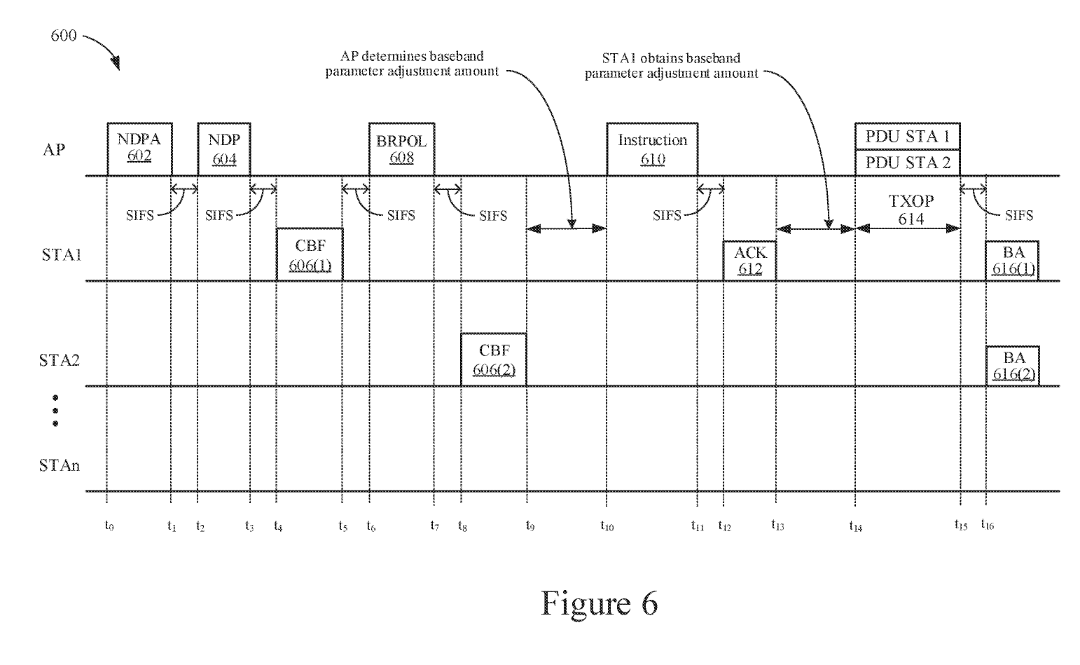

For some implementations, the AP may solicit CSI from the wireless devices STA1-STAn by initiating a channel sounding operation with the wireless devices STA1-STAn. For example, referring also to the timing diagram 600 of FIG. 6, the AP transmits a NDPA 602 to the wireless devices STA1-STAn between times t₀-t₁. The NDPA 602 may announce that the AP is to transmit a NDP 604, and may indicate which of wireless devices STA1-STAn are to respond to the NDP 604. In some aspects, the wireless devices STA1-STAn indicated by the NDPA 602 may be part of a MU-MIMO group. After a short inter-frame space (SIFS), between times t₁-t₂, the AP transmits the NDP 604 to wireless devices STA1-STAn between times t₂-t₃. The NDP 604 may contain a number of sounding sequences from which each receiving device can estimate channel conditions and generate CSI. The sounding sequences may be any suitable sequence or pattern that is known to the receiving devices.

For some implementations, the sounding sequences may be long training fields (LTFs) such as, for example, high-throughput LTFs (HT-LTFs), very high-throughput LTFs (VHT-LTFs), or high-efficiency LTFs (HE-LTFs). In some aspects, the NDP 604 may contain a number of orthogonal HE-LTFs, for example, to facilitate MIMO channel estimates using one or more antennas. In some aspects, the sounding sequences may be used to estimate angle of arrival (AoA) and/or angle of departure (AoD) information of signals transmitted from the AP, which in turn may be used to determine the angular positions of the wireless devices STA1-STAn relative to the AP (and therefore also determine the angular positions of the wireless devices STA1-STAn relative to each other).

At time t₄, which occurs a SIFS duration after time t₃, STA1 transmits a compressed beamforming (CBF) frame 606(1) to the AP. The CBF frame 606(1) may include a feedback matrix calculated by STA1 based on the sounding sequences contained in the NDP 604. The feedback matrix may contain CSI corresponding to the wireless link L1 between STA1 and the AP.

The AP 110 may receive the CBF frame 606(1) from STA1 between times t₄-t₅, and then transmit a beamforming report poll (BRPOL) frame 608 to STA2 between times t₆-t₇. The BRPOL frame 608 may indicate that STA2 is to transmit its CBF frame to the AP. In response thereto, STA2 may transmit a CBF frame 606(2) to the AP between times t₈-t₉. The CBF frame 606(2) may include a feedback matrix calculated by STA2 based on the sounding sequences contained in the NDP 604. The AP may transmit additional BRPOL frames 608 and receive additional CBF frames 606 from STA3-STAn in a similar manner. In some aspects, the CSI received from a given STA may indicate the channel conditions of the wireless link between the AP and the given STA. The channel conditions may include parameters such as, for example, scattering, fading, signal-to-noise ratio (SINR), power decay over distance, and so on. After receiving CBF frames 606 from wireless devices STA1-STAn, the AP may determine channel conditions for the wireless channels between the AP and each of the wireless devices STA1-STAn, and may determine a steering matrix for beamforming MU-MIMO transmissions to the wireless devices STA1-STAn.

In accordance with various aspects of the present disclosure, the AP may use the received CSI to determine, for each of wireless devices STA1-STAn, a level of channel correlation with the other wireless devices STA1-STAn. For some implementations, the AP may perform post processing on the CSI received from each of the wireless devices STA1-STAn to determine levels of channel correlation between each of the wireless devices STA1-STAn. In some aspects, the AP may use a correlation tree structure to determine the level of channel correlation between a respective one of wireless devices STA1-STAn relative to the other wireless devices STA1-STAn. For example, referring again to FIG. 5A, the AP may first select STA1 for channel correlation analysis, and then determine the level of channel correlation between link L1 (corresponding to STA1) and each of the other links L2-Ln (corresponding to STA2-STAn, respectively). The AP may then use the correlation tree structure to determine a level of channel correlation for STA1 that is based on a combination of the levels of channel correlation between link L1 and each of links L2-Ln.

In some aspects, the correlation tree structure is a greedy approach that iteratively selects greater numbers of wireless devices to form a MU-MIMO group while ensuring that levels of channel correlation between the wireless devices remain below the value. For example, referring again to FIG. 5A, the correlation tree structure may first form a MU-MIMO group to include a pair of the wireless devices STA1-STAn that have the lowest levels of channel correlation, then select a third of the wireless devices STA1-STAn to join the MU-MIMO group that results in the lowest levels of channel correlation between three wireless devices, and so on. In this manner, the access point 300 may consider only a subset of all possible combinations of wireless devices STA1-STAn to avoid the complexity of an exhaustive search of all possible combinations of wireless devices STA1-STAn when grouping the wireless devices STA1-STAn. In other words, the correlation tree structure may be used to identify, for a given MU-MIMO group size of N wireless devices, which N of the wireless devices STA1-STAn would form the MU-MIMO group that results in the lowest levels of channel correlation between the wireless devices (e.g., where N is an integer greater than or equal to 2).

The AP may then identify one or more of the wireless devices STA1-STAn for which the determined level of channel correlation with the other wireless devices STA1-STAn is greater than or equal to the value. For some implementations, the AP may compare the level of channel correlation for each of the wireless devices STA1-STAn with the value to identify which (if any) of wireless devices STA1-STAn may be instructed to adjust a parameter value, for example, to reduce its level of channel correlation with the other wireless devices STA1-STAn. More specifically, the AP may identify at least one of the wireless devices STA1-STAn based on the amount of channel correlation attributable to each of the identified wireless devices STA1-STAn. For some implementations, the AP may select a number of the identified wireless devices STA1-STAn having relatively high contributions to channel correlation between the identified wireless devices STA1-STAn (e.g., as compared to non-selected ones of the identified wireless devices STA1-STAn having relatively low contributions to the channel correlation) for parameter adjustments.

Thereafter, between times t₉ and t₁₀, the AP determines the amount by which the parameter is to be adjusted by one or more of the identified wireless devices STA1-STAn. In some aspects, the AP may determine the parameter adjustment amount only for a selected subset of the identified wireless devices STA1-STAn. In other aspects, the AP may determine the parameter adjustment amount for each of the identified wireless devices STA1-STAn.

For some implementations, the parameter may be a cyclic shift diversity (CSD), and the AP may determine, for each of the identified wireless devices STA1-STAn, a CSD value to be applied to signals received by the respective one of the identified wireless devices STA1-STAn. The CSD value determined by the AP may correspond to a desired phase shift that, when applied by a respective wireless device to received signals, may reduce the respective wireless device's level of channel correlation with the other wireless devices. Thus, in some aspects, the CSD level determined by the AP may represent a parameter adjustment amount to be applied by the respective wireless device in the frequency domain. In other aspects, the AP may determine the CSD level as a trigger point shift that may be applied by the respective wireless device to a received signal in the time domain. For example, the AP may determine a set of Fast Fourier transform (FFT) trigger point shift values and provide these FFT trigger point shift values as the parameter adjustment amount.

For other implementations, the parameter may be a set of attenuation (α) and time delay (n₀) values for each of the identified wireless devices STA1-STAn. A respective wireless device may apply a corresponding set of attenuation (α) and time delay (n₀) values to a received signal to generate an attenuated signal. The respective wireless device may add the attenuated signal to the received signal to generate an artificial multipath signal Y′[n]. Thereafter, the artificial multipath signal may be introduced into the receive path or chain of the respective wireless device, for example, to change the channel conditions as seen by the AP (e.g., in a manner that reduces the level of channel correlation between the identified wireless device and other nearby wireless devices). In some aspects, the artificial multipath signal may be expressed as follows:

Y′[n]=Y[n]+αY[n−n₀],

where Y[n] is the original received signal.

For some implementations, the AP may select the attenuation (α) and time delay (n₀) values from a finite set in a trial and error fashion to determine which set of values results in the greatest reduction in channel correlation between the respective wireless device and other wireless devices. In some aspects, the AP may set the attenuation value α=0.1 and may set the delay value n₀=1, which corresponds to a one-sample shift that is approximately 10 dB lower than the main channel component. In other aspects, the AP may set the attenuation value to a relatively small value that creates a weak second path, for example, to increase frequency selectivity. For other implementations, the AP may use multi-dimensional optimization technique to select, for each wireless device, attenuation (α) and time delay (n₀) values for reducing the correlation between channels of a plurality (e.g., a group) of wireless devices.

After determining the amount by which each of the identified wireless devices STA1-STAn is to adjust its parameter, the AP may generate one or more instructions containing the parameter adjustment amounts to be applied by at least one of the identified wireless devices STA1-STAn. The instructions may also indicate how each of the recipient wireless devices is to apply the parameter adjustment amounts. For one example, if the parameter is a CSD value, then the instructions may indicate whether the CSD adjustment value is to be applied in the frequency domain or in the time domain. For another example, if the parameter is a set of attenuation and delay values, then the instructions may request the recipient wireless device to apply the set of attenuation and delay values to a received signal to generate an attenuated signal, add the attenuated signal and the original received signal to generate an artificial multipath signal (Y′[n]), and then introduce the artificial multipath signal into one or more receive chains of the recipient wireless device.

For some implementations, the instructions may indicate when each of the recipient wireless devices is to adjust its parameter and/or may indicate a duration of time for which the parameter adjustments are to be applied. For one example, the instructions may request a respective recipient wireless device to adjust its parameter by the indicated amount at the next transmit opportunity (TXOP) or at a specified time. For another example, the instructions may request a respective recipient wireless device to adjust its parameter by the indicated amount for a selected number of TXOPs, for a selected duration of time, or until notified otherwise by the AP.

Then, the AP may provide the instructions for transmission to at least one of the identified wireless devices STA1-STAn. For the example of FIG. 6, the AP transmits an instruction 610 to STA1 at time t₁₀. Although the example of FIG. 6 depicts the AP transmitting the instruction 610 to only STA1 (e.g., because only STA1 may have been selected by the AP for parameter adjustments), for other implementations, the AP may transmit the instruction 610 to more than one of the wireless devices STA1-STAn. The instructions 610 may be transmitted using any suitable frame or packet. For some implementations, the instructions 610 may be provided within a suitable management frame such as, for example, an action frame. In some aspects, the instructions 610 may be contained within an IE of an action frame. In other aspects, the instructions 610 may be contained within a VSIE of an action frame.

The wireless device STA1 receives the instruction 610 between times t₁₀-t₁₁, and may acknowledge receipt of the instruction 610 by transmitting an acknowledgement (ACK) frame 612 to the AP at time t₁₂. The AP may receive the ACK frame 612 at time t₁₃. Between times t₁₁ and t₁₄, STA1 may decode the instruction 610, for example, to retrieve the determined amount and then adjust its parameter by the determined amount, for example, as discussed above.

Then, at time t₁₄, the AP may initiate DL MU-MIMO data transmissions during a TXOP 614. As depicted in FIG. 6, the AP transmits one or more PDUs to each of STA1 and STA2 using MU-MIMO communications between times t₁₄-t₁₅. Thus, for the example of FIG. 6, STA1 and STA2 may form a MU-MIMO group to concurrently receive DL data transmissions from the AP. For other implementations, one or more others of the wireless devices STA1-STAn may form the MU-MIMO group to receive DL data transmissions from the AP.

In some aspects, the beginning of TXOP 614 (at time t₁₄) may be the time at which STA1 is requested, by the instruction 610, to adjust its parameter by the amount indicated in the instruction 610. As discussed above, the instruction 610 may request STA1 to adjust its parameter by the indicated amount for a specified duration of time, or may request STA1 to adjust its parameter by the indicated amount until otherwise instructed by the AP.

The wireless devices STA1 and STA2 receive their respective PDUs from the AP, and may acknowledge receipt of the DL data by transmitting block acknowledgement (BA) frames 616(1) and 616(2), respectively, to the AP at time t₁₆. As depicted in FIG. 6, times t₁₅ and t₁₆ may be separated by a SIFS duration (as well as times t₅ and t₆, times t₇ and t₈, and times t₁₁ and t₁₂). For other implementations, one or more of the SIFS durations depicted in FIG. 6 may be any other suitable time period including, for example, a DIFS duration, a PIFS duration, an EIFS duration, and so on.

As mentioned above, the AP may select one or more of the wireless devices STA1-STAn to form a group based on their respective determined levels of channel correlation, and then concurrently transmit DL data to the group using MU-MIMO communications. In addition, for some implementations, the AP may continually or periodically monitor a MU-MIMO group to determine whether one or more wireless devices within the group may be removed from the group, to determine whether one or more wireless devices may be added to the group, and/or to determine whether one or more of the wireless devices within the BSS 500 may benefit from continued parameter adjustments or may benefit from no longer adjusting their parameters.

For example, FIG. 5B shows a block diagram depicting an example grouping 510 of the wireless devices of the BSS 500 of FIG. 5A in accordance with various aspects of the present disclosure. The AP may select a number of the wireless devices STA1-STAn to form a MU-MIMO group based on, for example, levels of channel correlation, per-peer queue depth and MAC efficiency. For one example, the AP may determine the queue depth of a given STA based on the amount of DL data buffered by the AP for the given STA. In some aspects, STAs having a relatively large amount of buffered DL data may be selected as candidates for the MU-MIMO group, while STAs having a relatively small amount of buffered DL data may not be selected as candidates for the MU-MIMO group. In this manner, STAs having relatively large amounts of buffered DL data may utilize the higher throughput of MU-MIMO communications (e.g., as compared with SU-MIMO or SISO communications). For another example, STAs having relatively high MAC efficiency may be selected as candidates for the MU-MIMO group, while STAs having relatively low MAC efficiency may not be selected as candidates for the MU-MIMO group.

For the example of FIG. 5B, the AP selects STA1-STA3 to form a MU-MIMO group 510; the other wireless devices (e.g., STAn) are not selected for inclusion in the MU-MIMO group 510. After the MU-MIMO group 510 is formed, the AP may receive updated CSI from the wireless devices in the MU-MIMO group 510 (e.g., from STA1-STA3), for example, by performing one or more channel sounding operations in the manner described above with respect to FIG. 5A. The AP may determine, for each of the wireless devices in the MU-MIMO group 510, an updated level of channel correlation with other wireless devices within the BSS 500 based, at least in part, on the updated CSI. The AP may identify one or more of the wireless devices in the MU-MIMO group 510 for which the updated level of channel correlation is greater than or equal to the value, and then remove the identified one or more wireless devices from the MU-MIMO group 510.

For some implementations, before removing the identified wireless devices from the MU-MIMO group 510, the AP may attempt to reduce the level of channel correlation associated with one or more of the identified wireless devices in the MU-MIMO group 510, for example, by instructing the one or more of the identified wireless devices to adjust their parameters (such as baseband parameters) in the manner described above with respect to FIG. 5A.

FIG. 7 is an illustrative flow chart depicting an example operation 700 for reducing channel correlation between a plurality of wireless devices. Although the example operation 700 is described below with respect to the access point 300 of FIG. 3 and wireless devices 400 of FIG. 4, it is to be understood that the example operation 700 may be performed by any suitable apparatus to reduce levels of channel correlation between any suitable wireless devices or nodes.

First, the access point 300 may receive channel state information (CSI) from each of a plurality of wireless devices (702). The CSI may be based on a number of sounding sequences. For example, referring also to FIG. 3, the processor 332 may execute the channel sounding software module 334B to perform channel sounding operations with other wireless devices 400 and to receive CSI from one or more of the other wireless devices 400. In some aspects, the access point 300 may transmit a NDP containing a number of sounding sequences to the wireless devices 400, and the wireless devices 400 may determine CSI and then provide the CSI to the access point 300 in feedback frames, for example, as described above with respect to FIG. 6. In some aspects, the CSI may be received by the interface 305 of the access point 300 of FIG. 3.

Next, the access point 300 may determine, for each of the plurality of wireless devices 400, a level of channel correlation with other wireless devices 400 based, at least in part, on the received CSI (704). For example, the processor 332 may execute the channel correlation determination software module 334C to determine the levels of channel correlation between the plurality of wireless devices 400.

The access point 300 may identify one or more of the plurality of wireless devices 400 for which the determined level of channel correlation is greater than or equal to a value (706). For example, the processor 332 may execute the channel correlation determination software module 334C to identify wireless devices 400 for which the determined level of channel correlation is greater than or equal to the value. As discussed above, in some aspects, the value may correspond to a level of channel correlation for which inter-channel interference is sufficient to degrade MU-MIMO data transmissions from the access point 300 to the wireless devices 400. In other aspects, the value may indicate a maximum level of channel correlation for which a number of corresponding wireless devices 400 may be grouped together for MU-MIMO communications with the access point 300.

Then, the access point 300 may generate an instruction requesting at least one of the identified wireless devices 400 to adjust a parameter by an amount based on the determined level of channel correlation (708). For example, the processor 332 may execute the parameter determination software module 334D to determine the parameter adjustment amount for each of the at least one of the identified wireless devices 400, and may execute the frame formatting and exchange software module 334A to generate an action frame containing instructions requesting the at least one of the identified wireless devices 400 to adjust its parameter by the amount indicated in the instruction.

For other implementations, the access point 300 may identify a selected number of the identified wireless devices 400 that cause the most channel correlation (e.g., as compared to the channel correlation caused by the non-selected wireless devices), and then determine parameter adjustment amounts only for the selected number of the identified wireless devices 400.

Thereafter, the access point 300 may provide the instruction for transmission to the at least one of the identified wireless devices (710). For example, the instruction may be provided to the baseband processor 320 for transmission via transceivers 310 and one or more of antennas 340(1)-340(n).

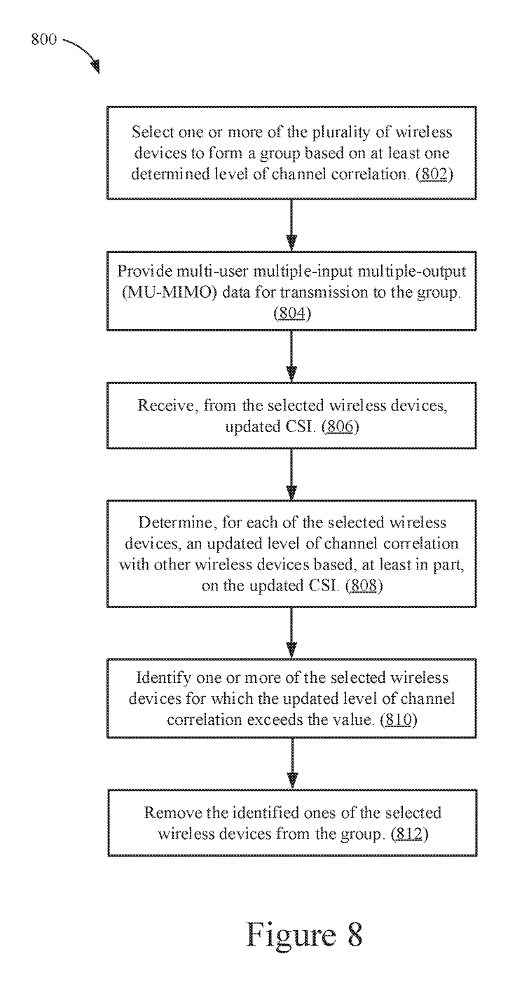

FIG. 8 shows an illustrative flow chart of an operation 800 for grouping a number of wireless devices together for MU-MIMO communications in accordance with various aspects of the present disclosure. Although the example operation 800 is described below with respect to the access point 300 of FIG. 3 and wireless devices 400 of FIG. 4, it is to be understood that the example operation 800 may be performed by any suitable apparatus to reduce levels of channel correlation between any suitable wireless devices or wireless nodes.

First, the access point 300 may select one or more of the plurality of wireless devices 400 to form a group based on at least one determined level of channel correlation (802). For example, the processor 332 may execute the grouping software module 334E to select a number of the wireless devices 400 to form a MU-MIMO group. The access point 300 may provide MU-MIMO data for transmission to the group (804). For example, the MU-MIMO data may be provided to the baseband processor 320 for transmission via transceivers 310 and one or more of antennas 340(1)-340(n).

The access point 300 may receive, from the selected wireless devices 400, updated CSI (806). For example, the processor 332 may execute the channel sounding software module 334B to perform channel sounding operations with the wireless devices 400 and to receive CSI from one or more of the wireless devices 400. In some aspects, the access point 300 may continually or periodically perform channel sounding operations with the wireless devices 400 to obtain updated CSI from the wireless devices 400, as described above with respect to FIG. 6.

Then, the access point 300 may determine, for each of the selected wireless devices 400, an updated level of channel correlation with other wireless devices 400 based, at least in part, on the updated CSI (808). For example, the processor 332 may execute the channel correlation determination software module 334C to determine updated levels of channel correlation between each of the selected wireless devices 400 and the other wireless devices 400.

The access point 300 may identify one or more of the selected wireless devices 400 for which the updated level of channel correlation is greater than or equal to the value (810). For example, the processor 332 may execute the channel correlation determination software module 334C to identify one or more of the selected wireless devices 400 for which the determined level of channel correlation is greater than or equal to the value.

Then, access point 300 may remove the identified ones of the selected wireless devices 400 from the MU-MIMO group (812). For example, the processor 332 may execute the grouping software module 334E to remove the identified ones of the selected wireless devices 400 from the MU-MIMO group.

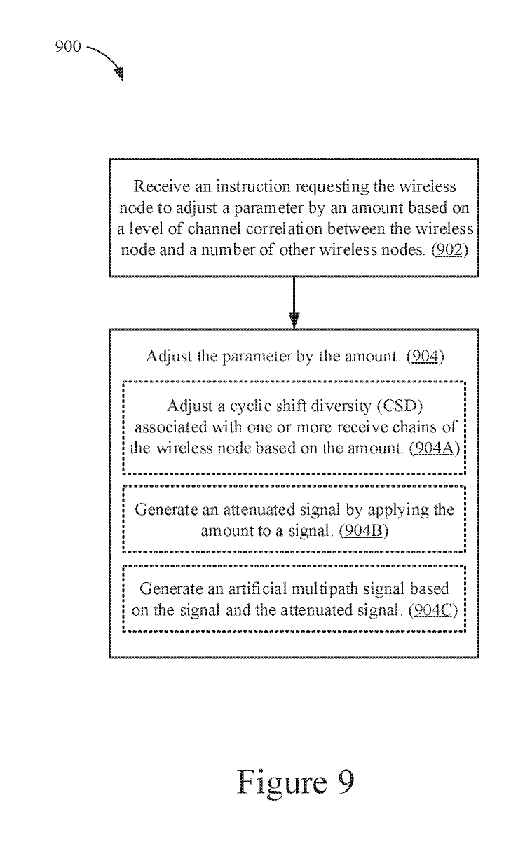

FIG. 9 shows an illustrative flow chart of an operation 900 for reducing channel correlation between a selected wireless device and a number of other wireless devices in accordance with various aspects of the present disclosure. Although the example operation 900 is described below with respect to the access point 300 of FIG. 3 and wireless devices 400 of FIG. 4, it is to be understood that the example operation 900 may be performed by any suitable apparatus to reduce levels of channel correlation between any suitable wireless devices or nodes.

The wireless device 400 may receive (from the access point 300) an instruction requesting the wireless device 400 to adjust a parameter by an amount based on a level of channel correlation between the wireless device 400 and a number of other wireless devices (902). In some implementations, the access point 300 may receive channel state information (CSI) from the wireless device 400 and each of the other wireless devices, and may determine the level of channel correlation based, at least in part, on the received CSI. For example, the access point 300 may identify wireless devices 400 for which the determined level of channel correlation is greater than or equal to a value. The amount by which the parameter is to be adjusted may be selected to reduce the level of channel correlation to an amount that is less than the value. As discussed above, in some aspects, the value may correspond to a level of channel correlation for which inter-channel interference is sufficient to degrade MU-MIMO data transmissions from the access point 300 to the wireless devices 400. In other aspects, the value may indicate a maximum level of channel correlation for which a number of corresponding wireless devices 400 may be grouped together for MU-MIMO communications with the access point 300.

The wireless device 400 may adjust the parameter by the amount (904). In some implementations, the parameter comprises a cyclic shift diversity (CSD) value, and the wireless device 400 may adjust the CSD associated with one or more of its receive chains based on the CSD value (904A). For example, the wireless device 400 may apply the adjusted CSD to received signals to reduce the level of channel correlation between itself and one or more other wireless devices.

In other implementations, the parameter comprises an attenuation value, and the wireless device 400 may generate an attenuated signal by applying the attenuation value to a signal (904B). In addition, or as an alternative, the wireless device 400 may generate an artificial multipath signal based on the signal and the attenuated signal (904C). More specifically, in some aspects, the parameter may be a set of attenuation (α) and time delay (n₀) parameters, and the amount may be attenuation and time delay values that are applied to received signals by the wireless device 400. For example, the wireless device 400 may apply the attenuation and delay values to a signal to generate an attenuated signal, and then generate an artificial multipath signal by summing the signal and the attenuated signal. The artificial multipath signal may be introduced into the receive path or chain of the wireless device 400, which in turn may change the channel conditions as seen by the access point 300.

In some cases, rather than actually transmitting a frame, a device may include an interface to output a frame for transmission. For example, a processor may output a frame, via a bus interface, to a radio frequency (RF) front end for transmission. Similarly, rather than actually receiving a frame, a device may have an interface to obtain a frame received from another device. For example, a processor may obtain (or receive) a frame, via a bus interface, from an RF front end for reception. The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

For one example, in some aspects, a means for receiving channel state information (CSI) from a plurality of wireless devices may comprise or correspond to a receiver (e.g., the receiver unit 222) and/or an antenna(s) 224 of the access point 110 illustrated in FIG. 2 or the transceivers 310 and antennas 340(1)-340(n) of the access point 300 depicted in FIG. 3. In other aspects, the means for receiving CSI from a plurality of wireless devices may comprise an interface, for example, as described above with respect to FIGS. 1-3.

In some aspects, a means for determining, for each of the plurality of wireless devices, a level of channel correlation with other wireless devices based, at least in part, on the received CSI may comprise or correspond to a controller (e.g., the controller 230) of the access point 110 of FIG. 2 or a processing system disclosed herein (e.g., the processing system 330 of FIG. 3). For some implementations, the means for determining, for each of the plurality of wireless devices, a level of channel correlation with other wireless devices may correspond to the channel correlation determination software module 334C of FIG. 3.

In some aspects, a means for identifying one or more of the plurality of wireless devices for which the determined level of channel correlation is greater than or equal to a value may comprise or correspond to a controller (e.g., the controller 230) of the access point 110 of FIG. 2 or a processing system disclosed herein (e.g., the processing system 330 of FIG. 3). For some implementations, the means for identifying one or more of the plurality of wireless devices for which the determined level of channel correlation is greater than or equal to the value may correspond to the channel correlation determination software module 334C of FIG. 3.

In some aspects, a means for generating an instruction requesting at least one of the identified wireless devices to adjust a parameter by an amount based on the determined level of channel correlation may comprise or correspond to a controller (e.g., the controller 230) of the access point 110 of FIG. 2 or a processing system disclosed herein (e.g., the processing system 330 of FIG. 3). For some implementations, the means for generating an instruction requesting at least one of the identified wireless devices to adjust a parameter by the amount may correspond to the parameter determination software module 334D of FIG. 3.

In some aspects, a means for providing the instruction for transmission to the at least one of the identified wireless devices may comprise or correspond to a controller (e.g., the controller 230) of the access point 110 of FIG. 2 or a processing system disclosed herein (e.g., the processing system 330 of FIG. 3). For some implementations, the means for means for providing the instruction for transmission to the at least one of the identified wireless devices may correspond to the frame formatting and exchange software module 334A of FIG. 3.

For another example, in some aspects, a means for receiving an instruction requesting an apparatus to adjust a parameter by an amount based on a level of channel correlation between the apparatus and a number of wireless nodes may comprise or correspond to a receiver (e.g., the receiver unit 254) and/or antenna(s) 252 of the user terminal 120 illustrated in FIG. 2 or the transceivers 410 and antennas 440(1)-440(n) of the wireless device 400 depicted in FIG. 4. In other aspects, the means for receiving an instruction may comprise an interface, for example, as described above with respect to FIGS. 1, 2, and 4.

In some aspects, a means for adjusting the parameter by the amount may comprise or correspond to a controller (e.g., the controller 280) of the user terminal 120 of FIG. 2 or a processing system disclosed herein (e.g., the processing system 430 of FIG. 4). For some implementations, the means for adjusting the parameter by the amount may correspond to the parameter adjustment software module 434C of FIG. 4.

According to certain aspects, such means may be implemented by processing systems configured to perform the corresponding functions by implementing various algorithms (e.g., in hardware or by executing software instructions) described above for generating frames for transmission during a sector sweep procedure.

As used herein, the term “generating” encompasses a wide variety of actions. For example, “generating” may include calculating, causing, computing, creating, determining, processing, deriving, investigating, making, producing, providing, giving rise to, leading to, resulting in, looking up (e.g., looking up in a table, a database or another data structure), ascertaining and the like. Also, “generating” may include receiving (e.g., receiving information), accessing (e.g., accessing data in a memory) and the like. Also, “generating” may include resolving, selecting, choosing, establishing and the like.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Also, “determining” may include measuring, estimating and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any such list including multiples of the same members (e.g., any lists that include aa, bb, or cc).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communication, comprising:
an interface configured to receive channel state information (CSI) from each of a plurality of wireless nodes; and
a processing system configured to:
determine, for each of the plurality of wireless nodes, a level of channel correlation with other wireless nodes based, at least in part, on the received CSI;
identify one or more of the plurality of wireless nodes for which the determined level of channel correlation is greater than or equal to a value; and
generate an instruction requesting at least one of the identified wireless nodes to adjust a parameter by an amount based on the determined level of channel correlation, wherein the interface is further configured to provide the instruction for transmission to the at least one of the identified wireless nodes.

2. The apparatus of claim 1, wherein the determination is further based on a correlation tree structure.

3. The apparatus of claim 1, wherein the parameter comprises a cyclic shift diversity (CSD) value.

4. The apparatus of claim 1, wherein the parameter comprises an attenuation value, and the instruction requests the at least one of the identified wireless nodes to generate an attenuated signal by applying the attenuation value to a signal.

5. The apparatus of claim 4, wherein the instruction requests the at least one of the identified wireless nodes to generate an artificial multipath signal based on the signal and the attenuated signal.

6. The apparatus of claim 1, wherein:
the processing system is further configured to generate an action frame containing the instruction; and
the interface is further configured to provide the action frame for transmission to the at least one of the identified wireless nodes.

7. The apparatus of claim 1, wherein:
the processing system is further configured to select one or more of the plurality of wireless nodes to form a group based on at least one determined level of channel correlation and to generate multi-user multiple-input multiple-output (MU-MIMO) data for the group; and
the interface is further configured to provide the MU-MIMO data for transmission to the group.

8. The apparatus of claim 7, wherein:
the interface is further configured to receive, from the selected wireless nodes, updated CSI; and
the processing system is further configured to:
determine, for each of the selected wireless nodes, an updated level of channel correlation with other wireless nodes based, at least in part, on the updated CSI;
identify one or more of the selected wireless nodes for which the updated level of channel correlation is greater than or equal to the value; and
remove the identified one or more of the selected wireless nodes from the group.

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. An apparatus, comprising:
an interface configured to receive an instruction requesting the apparatus to adjust a parameter by an amount based on a level of channel correlation between the apparatus and a number of wireless nodes; and
a processing system configured to adjust the parameter by the amount.

27. The apparatus of claim 26, wherein the parameter comprises a cyclic shift diversity (CSD) value, and the processing system is further configured to adjust the CSD associated with one or more receive chains of the apparatus based on the CSD value.

28. The apparatus of claim 26, wherein the parameter comprises an attenuation value, and the processing system is further configured to generate an attenuated signal by applying the attenuation value to a signal.

29. The apparatus of claim 28, wherein the processing system is further configured to generate an artificial multipath signal based on the signal and the attenuated signal.

30. The apparatus of claim 29, wherein the processing system is further configured to introduce the artificial multipath signal into a receive path of the apparatus.

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. An access point, comprising:
a transceiver configured to receive channel state information (CSI) from each of a plurality of wireless devices; and
a processing system configured to:
determine, for each of the plurality of wireless devices, a level of channel correlation with other wireless devices based, at least in part, on the received CSI;
identify one or more of the plurality of wireless devices for which the determined level of channel correlation is greater than or equal to a value; and
generate an instruction requesting at least one of the identified wireless devices to adjust a parameter by an amount based on the determined level of channel correlation, wherein the transceiver is further configured to transmit the instruction to the at least one of the identified wireless devices.

44. The apparatus of claim 26, further comprising at least one antenna via which the instruction is received, wherein the apparatus is configured as a wireless node.
